(19) United States
(12) Patent Application Publication
(10) Pub. No.: US 2002/0064302 A1
(43) Pub. Date: May 30, 2002

(54) Virtual cosmetic autosurgery via telemedicine

(76) Inventor: R. Kemp Massengill, Leucadia, CA (US)

Correspondence Address: GERALD W SPINKS, P. O. BOX 2330, PORT ORCHARD, WA, 98366, US

(21) Appl. No.: 09/769,016

(22) Filed: Jan. 19, 2001

Related U.S. Application Data
(60) Provisional application No. 60/195,795, filed on Apr. 10, 2000.

(51) Int. Cl. G06F 7/38

(52) U.S. Cl. 382/128; 712/225

(57) ABSTRACT

A method and apparatus for performing virtual cosmetic surgery by inputting a patient's image, personal data, and proposed image modification scheme into one of a plurality of remote computers, with the image and the modification scheme being analyzed and modified by a central computer, thereafter displaying a modified patient image at the remote computer, with the central computer being connected to the plurality of such remote computers via the Internet.

### CROSS REFERENCE TO RELATED APPLICATIONS

This application claims priority from U. S. Provisional Patent Application Ser. No. 60/195,795, filed Apr. 10, 2000, for “Virtual Cosmetic Autosurgery Via Telemedicine.”

### STATEMENT REGARDING FEDERALLY SPONSORED RESEARCH OR DEVELOPMENT

Not Applicable

### BACKGROUND OF THE INVENTION

1. Field of the Invention

This application is in the field of medical diagnostic tools implemented via the Internet.

2. Background Art

The medical specialties of plastic and cosmetic surgery have expanded dramatically in recent years, driven by increased affluence and more critical self-inspection. For instance, 32,000 breast implant augmentations were performed in 1992, compared with 132,000 in 1998, a gain of 412 percent. Further, 40,000 face lifts were performed in 1992, while 70,000 were performed in 1998, a gain of 175 percent. Media examples of beauty, health, and well-being are ubiquitous, and people of everyday means now aspire to match these ideals.

With the burgeoning interest of the general public in a variety of plastic and cosmetic surgery procedures, a patient frequently wishes to learn in advance of surgery how he or she will look postoperatively. Based upon an appraisal of the possibilities for improved cosmesis, a prospective patient may choose to go forward with the surgical procedure in question, with a good concept of how the surgery will affect ultimate appearance.

To facilitate the education process of a person interested in cosmetic plastic surgery, several companies have introduced computer software programs which have the capability of modifying the appearance of a prospective patient. These simulation and morphing software programs are commercially targeted for offices of surgeons performing cosmetic and plastic procedures, and constitute a useful tool in helping patients to better understand a particular cosmetic procedure and the effect of that procedure on the patient's final postoperative appearance, should surgery be elected by the patient.

A leading system for cosmetic surgery simulations is called the Mirror Suite™ Total Patient Imaging Software. A surgeon's office with this system is able to have patients watch on screen as they are guided from their current appearance to a representative post-operative outcome (www.canfieldsci.com). Employing morphing and simulation tools, the Mirror Suite™ imaging system is applicable for resurfacing simulation, hair restoration tools, hair loss simulation, and image management. Also provided are draw and warp tools, and tools for simulated breast augmentation.

The Canfield Mirror Suite™ software system can be incorporated with the Canfield DermaGraphix™ Dermatology Imaging Software system, which offers dermatologists a complete digital imaging system, utilized for serially tracking over time skin lesions located on the body of a patient. This system is used for pigmented lesions, and body mapping is also useful for documenting psoriasis, eczema and other conditions. Images purportedly can be compressed sufficiently to be sent via e-mail or posted on a web page.

No description is made in the Canfield website or brochures, however, of a patient having the ability to automodulate his or her own appearance completely automatically and completely on-line via the Internet or other long-distance carrier, without an intervening technician or other support personnel. In the Canfield system, then, it is not the patient, but the technician who is in charge of the simulation and morphing functions.

Another company involved in an imaging and archiving system for the plastic and cosmetic surgical arena is United Imaging, Inc., which commercially offers its MarketWise™ Imaging and Archiving System. Featuring a high resolution camera, patient photographs can be taken (www.uimaging.com). A color LCD on the camera can allow for instant review of images and shows camera settings for each image. The color LCD on the digital camera typically operates in live mode until the picture is snapped. Voice files may be saved with each picture. The MarketWise™ Imaging Systems have specially designed programs for simulation of hair replacement, laser resurfacing, and upper blepharoplasty. MarketWise™ Imaging includes advanced tools for cloning, morphing, and symmetrical morphing. Volumetric morphing simulates breast enlargement and reduction. An automorph function allows morphing without first defining a region. Using computer imaging as an integral part of the consultation process is a proven practice builder, adding increased patient understanding and the confidence to proceed with proposed procedures.

As with the Canfield Mirror Suite™ software system, however, the United Imaging MarketWise™ system does not allow automodulation by the patient on an interactive on-line basis.

United Imaging also provides its CaseView™ system, which presents notable surgery cases to prospective patients via an interactive presentation kiosk. This interactive computer program invites prospective patients to view a surgeon's cases by choosing from interactive menus those procedures that interest them most. By simply pressing the on-screen buttons, the viewer moves through presentations of the cases, information about the surgeon's practice, and the services and products the surgeon offers. A CaseView™ interactive system can be positioned in a waiting area, a consultation room, or another public area. The patient cannot morph or modulate his or her own appearance, however.

A third product of United Imaging is its NewPatient™ Package, which makes it possible for a surgeon to contact prospective patients where they live, work and play, all day, every day, in spas, salons, health clubs, malls and medical centers. The NewPatient™ Package is an interactive CD program using a touchscreen monitor to provide interaction between the patient and the program. This interactive program allows the viewer to choose topics of particular interest. The viewer moves through the program at his or her own pace, stopping to take more time for review, or moving ahead to choose other topics designed to educate viewers about today's plastic surgery techniques. Prospective patients can call a surgeon's office for a consultation or more information. Similar to the above-described systems, however, the patient cannot morph or change his or her appearance with this product.

The Niamtu Imaging System software is also available (www.niamtu.com). The website describes software including the TIMS (Total Image Management) professional image editing, presentation software, sophisticated archiving software, image capture software, global viewing software, fast formatting, web tools, the ability to add pictures to referral letters, and others. For orthodontic and cosmetic formatting, Niamtu Imaging System is especially designed for Windows 95 and 98 and Microsoft Office. Using this system, the purchaser is able to perform a variety of tasks, including “pick and apply” editing which facilitates real-time imaging changes. Images can be dragged and dropped into referral letters and other documents. The system has autoprocessing tools which automatically straighten, crop, focus, and adjust for color and brightness with the click of a mouse. It also has other special effects that allow a surgeon to create Internet pages, and to catalogue any image from a patient to an art collection. Included is a tool for morphing. The system is useful for laser resurfacing, as well as being useful for orthodontic and cosmetic surgery formatting. Web tools are also provided to create web pages. The system is available on CD-ROM only, with an instructional video and manual. A digital camera is recommended for capturing digital images.

A section of the Niamtu website entitled “The Magic of Image Morphing,” states that the software will automatically redraw changes made by the user, and the color, shadow and contrast will be calculated automatically, usually within seconds. Moving the control points redraws the image in real time. Morphing can be done on any anatomical area from breast to tooth. The user may also zoom in on a specific body part, such as the nose, chin, etc., and isolate the structure which gives the user more control points and more precise changes without disturbing the rest of the anatomy. Besides morphing, the Niamtu Imaging System allows the user to rotate any anatomy, including straightening a tooth or rotating a nasal tip. Text can also be added to any image.

The Niamtu website has a “Presentation and Marketing” section, and an “album function,” which allows the user to place images in an album in thumbnail format. Once the images are saved to an album, the user can make multimedia slide shows using the images. These slide shows may be interfaced with programs like Microsoft Power Point to make custom lectures and professional publications. They can even be posted on the Internet. Additionally, the system provides for the development of custom databases, with which it is possible to categorize and retrieve images based upon specific search parameters, such as treatment complications from a specific procedure. Sophisticated “Image Archiving” is available with the Niamtu system, which allows the ability to store images in over 40 formats, such as jpg, bmp, tigg, gif, pcx and others. Compression is used to preserve hard drive memory.

The “Internet and Web Tools” section of the website indicates that, in the future, imaging will rely more and more on the World Wide Web. A SmartSaver tool is provided, which allows the user to optimize images so when placed on the Internet, they download quickly. The Niamtu system also offers other special effects.

Akin to the Canfield imaging systems and those of United Imaging, Inc., however, the Niamtu imaging system does not disclose or suggest the patient's ability to automodulate his or her appearance completely on-line and without the help of a technician.

The Plastic Surgery Company of Santa Barbara, California (www.idealme.com) also provides a personal imaging service. The “Computer Imaging” section invites a potential prospect for cosmetic plastic surgery to submit the prospect's own photo, which will then be manipulated by a medical illustrator to indicate the probable results of the prospect's preferred procedures.

The computer imaging section of this website is Internet-based, from the point of view that a person interested in cosmetic plastic surgery transmits a scanned photograph on-line directed to the medical illustrators on the staff of the Plastic Surgery Company, and, after these professionals morph the original photographs, the new photographs depicting the possibilities of cosmetic improvement via the vehicle of plastic surgery are transmitted on-line back to the prospective candidate for surgery. At no time, however, do patients themselves have the opportunity to change their appearance or to experiment with the various simulation and morphing options.

Another computerized system is available in the form of a kit which allows the purchaser to modify the appearance of one's hair and makeup, with the software making appropriate hair and makeup changes, depending on the likes and dislikes of the customer. This product is neither on-line, however, nor does it address cosmetic or plastic surgery. In other words, this software system does not change facial or body features, but merely allows the buyer to change hair and makeup. This system is far removed from either cosmetic plastic surgery or virtual telemedicine autosurgery.

Another option is available for a patient interested in cosmetic plastic surgery, but this requires making an appointment with a cosmetic or plastic surgeon. Many surgeons performing plastic surgery have in-office trained personnel who will consult with a potential patient and make computer-driven changes in the patient's appearance which simulate the expected result from proposed surgery, provided, of course, that complications do not occur which could mar the final result. This is a valuable service, but, because of the environment of having the computer simulations performed by the surgeon's staff (or by the surgeon himself or herself), patients may feel pressure to consent to the surgery in question, and, thus, may not concentrate as well as if they were in their own homes. Even if the computer-modulated photographs are given to the patient to take home for further study, the patient has no opportunity whatsoever to automodulate personal appearance or to make further changes.

A need exists, therefore, for a system which allows patients to make software-driven changes in their appearance on-line in the comfort and tranquility of their own homes, without feeling any undue pressure to consent to a surgical procedure which may, or may not, be wanted.

### BRIEF SUMMARY OF THE INVENTION

The present invention of virtual cosmetic autosurgery via telemedicine constitutes a new way of performing surgical simulations and morphing. The patient is in complete command of the morphing and simulation functions, and, interestingly, such an individual is not only the patient, but also becomes the surgeon; hence, the term, “autosurgery.” An image of the patient is provided to a central computer. The patient uses a remotely located computer to connect to the central computer, via a data transmission system, such as the Internet. The patient can then input other patient data, as well as inputting desired modifications to the patient's own image, such as a face lift or breast augmentation. The patient can view the results of the modifications on the remotely located computer. The present invention, in other words, provides the ability for the patient to be in control of directing the software which controls the simulation process. The patient at a distant site, in essence, becomes the “surgeon” and directs the chosen procedure via interactive discourse with the computer software system at the central processing site.

The novel features of this invention, as well as the invention itself, will be best understood from the following description.

### DETAILED DESCRIPTION OF THE INVENTION

The present invention operates in the following manner. A patient scans one or more photographs of the face, or other area of the body contemplated for virtual cosmetic autosurgery, into a home or office computer. Generally, frontal and profile views are required for optimal and realistic results. Alternatively, a photograph is mailed in to a provider of the simulation services, or a video camera attached to an office or home computer digitally scans the patient's face or body directly into the computer's memory, obviating the need for a photograph to be available. The content of the software selects appropriate views, with the most useful being frontal and profile views. Three dimensional modeling, which requires 360 degree views for best results, could also be used. As video camera attachments become ubiquitous, this alternative is envisioned as the future preferred embodiment. Until such time as suitable-quality video cameras for attachment to computers become commonplace, however, pictures captured with either analog, or preferably, the newer digital cameras, will suffice to provide the platform for cosmetic plastic autosurgical simulations and morphings.

The digitized pictures obtained as described above are transmitted from the distant remote site, i.e., the home or office of the patient, to the company's central processing computer site, for example via long-distance carrier, preferably the Internet, and then appropriately calibrated and sized by the central site's system software, such that these will be compatible in size, position, and view angle for the surgical procedural options available. For instance, if one's nose is to undergo virtual cosmetic autosurgery, it is vital that the original photographs be proportioned and scaled in such a way that the virtual surgical nose options can be superimposed properly onto the original photographs. This requires proper sizing of the original photographs as the beginning first step. To elaborate, an individual may prefer, among other virtual surgical options, to have a “smaller” nose, a “bigger” nose, a more “pointed” nose, a “flatter” nose, a “straighter” nose, a “thinner” nose, a nose without a “hump,” or a nose with a “hump,” etc., but, in all of these cases, it is imperative that the original photographs be digitized and then automatically sized and proportioned in such a manner that uniformity and standardization are achieved. If thousands of persons simultaneously wish to perform realistic virtual autosurgery via telemedicine, such standardization is mandatory for the entire network to function properly and for patients to be able to assess accurately the results of their telemedicine virtual autosurgery. It would most highly undesirable, for instance, if a patient's new virtual autosurgical nose also covered his or her mouth, due to improper sizing of the original photograph.

Once a person's original photographs have been properly sized and standardized according to preset norms for size, position, and view angle, (i.e., frontal, profile, etc.) by the computer at the central processing site, virtual autosurgery commences telemetrically with the “surgeon”/patient (one and the same person) selecting the desired cosmetic or plastic surgical procedure from the menu of those available. For example, if a patient wishes a new nose, or a modification to his or her existing nose, instructions would be transmitted to the central processing site that the body area to be operated was “The Nose.” The autosurgery would then be performed interactively with transmissions back and forth between the patient at a distant remote site and the central processing site. The “surgeon”/patient would answer appropriate questions posed by the central processing site, such as, “Is your nose too small?”, or, “Do you wish a nose without an uptilt at the tip?” Depending upon how the question is answered, the central processing site's computer software is programmed appropriately such that the new nose desired by the “surgeon”/patient is transmitted from the central processing site to the “surgeon”/patient's distant remote site and is properly oriented and then appropriately pictorially displayed on the computer screen.

In addition to a wide variety of different cosmetic plastic surgical procedures, a variety of different “surgical” options is available for each procedure. A reasonable number of such surgical options for virtual nose autosurgery is believed at this time to be at least twenty different noses. The patient can move, with either a mouse or keyboard, the new nose to cover the original nose, or preferably, the central processing system performs this function automatically at the command of the “surgeon”/patient. For instance, “Please give me nose number 12,” would be a representative request, and the new nose is automatically inserted in the proper place, via the software of the central processing computer. The “surgeon”/patient then views his or her new nose from various views, including frontal, profile, and, ultimately, in a rotational 3-D fashion for a full 360 degrees. The central processing site's computer software automatically makes appropriate skin shading corrections and skin color matches in such a manner that complete realism is maintained. The “surgeon”/patient is allowed to further smooth and modulate the morphed result.

The “surgeon”/patient is, therefore, performing this autosurgery completely without interventional help or support of a technician, doctor, or other human person. In summary, the entire virtual telemedicine process is completely and totally automated, with no human intervention whatsoever from the central processing site; and, of course, the autosurgery is instantly reversible with the press of a button. Complications are impossible, as the autosurgery is virtual.

The patient can store the finished virtual surgical procedure in the hard-drive of his or her home or office computer, or, alternatively, on a separate floppy disc, or other available and suitable storage medium. Printouts in black and white, and, if a color printer is available, in color, are another option for the “surgeon”/patient.

To make the final virtual autosurgical result as realistic as possible before proceeding to the surgery itself, the central processing site's software first establishes a baseline by asking pertinent questions, such as the patient's sex, age, height, weight, skin color and tone, etc, as each surgical procedure is available in a variety of subsets. For instance, a chin augmentation procedure for an otherwise normal 22 year-old patient is generally a much different procedure from a chin augmentation for a 60 year-old who also has a substantial “turkey-gobble” fat pad. In a real-life surgical setting, this fat pad must be dealt with, and, as verisimilitude is paramount, the present invention must, likewise, deal, virtually, with these valid differences.

To continue with this example, the present invention solves this problem by utilizing appropriate software which distinguishes simple chin recession from chin recession associated with a “turkey-gobble” fat pad. The central processing site's software is comprehensive, and is ongoingly and rigorously updated as new challenges are presented. For instance, if a new real-life cosmetic or plastic surgical procedure is developed, this new procedure is then incorporated into the armamentarium of the central processing site's software and is subsequently available for virtual autosurgery.

As more sophisticated software is developed, 3-dimensional imaging with full active rotational modeling will be embodied. Similar 3-dimensional modeling is currently being utilized by certain academic research medical institutions, as well as in the aerospace industry. Long-distance carrier bandwidth is expanding rapidly and exponentially, which means that much less compression will be required for these complex photographic and video transmissions.

It is preferable that patients “operate” on themselves on only one body site at a time. Of course, if a patient wishes, multiple operations can be performed, such as, but not limited to, virtual autosurgical nose surgery (rhinoplasty), ear surgery, chin procedures, eyelid cosmetic procedures, facelifts, skin resurfacing procedures and scar removals, breast augmentations or reductions, neck reductions (“turkey-gobble” necks), etc. For the most realistic results and those which most accurately simulate reality, however, virtual autosurgical procedures should be performed sequentially, rather than simultaneously. It is preferable and more logical to operate on one body part first, and then the next, rather than both at the same time.

In summary, any plastic or cosmetic procedure which can be performed in a standard operating room can be simulated and performed on-line by the patient himself or herself (virtual autosurgery) utilizing the present invention. The present invention enables a person to be both surgeon and patient, and, as the environment is virtual and not real, no real surgical harm can be done. Options for improved appearance via virtual cosmetic autosurgery can be explored in a completely safe and complication-free environment, with no physical risk whatsoever to the patient. Furthermore, rather than simulations performed in a doctor's office, where a technician or the surgeon is in control of the virtual modeling, with the present invention, the patient is the “surgeon” and is in complete charge in the non-stressful environment of his or her own home or office. In fact, the act of autosurgery may be psychologically beneficial to such individuals. As the virtual autosurgery of the present invention is completely automated and on-line, thousands of “surgeon”/patients can simultaneously undergo, via telemedicine, virtual autosurgical procedures.

Certainly, the patient may wish to take pictures or a floppy disc, or other suitable storage medium, of the finished autosurgical procedure to a qualified plastic or cosmetic surgeon, but there is certainly no need or pressure placed to do so. Consulting with a real-life plastic or cosmetic surgeon is entirely optional, based on an individual's wishes. This differs quite substantially from a doctor's in-office computer modeling consultations, which are typically performed in the surgeon's office by a technician. In these situations, patients generally may have either intended or unintended pressure exerted to have one, or another, surgical procedure.

The Plastic Surgery Company's strategy, described above, is “on-line,” but the surgery is not autoperformed. Rather, trained technicians perform the virtual surgery over a 24-hour period, and then transmit the final result back to the patient via the Internet. At no time does the patient herself or himself have the on-line opportunity (or any opportunity) to self-operate. The final pictures are the by-product of the technician's ingenuity, personal biases, and views of the ideal, rather than, more democratically, representing the true wishes and desires of the patient, as is the case with the present invention. With the present invention, the patient herself or himself has the risk-free (and interesting) experience of performing autosurgery—all without physical risk and completely reversible with the push of a button, without pressure to sign up for real-live surgery—with real-live attendant risks—and with extremely minimal expense, such as a nominal on-line charge. Even an individual of limited means should be able to afford the present invention's telemetric virtual cosmetic autosurgery. A most novel aspect of the present invention, then, centers around a person's ability to interactively alter one's virtual appearance oneself via virtual telemedicine.

By constantly and diligently updating the central processing system's software programs, the present invention provides instant accessibility at all times (i.e., seven days a week, twenty-four hours a day) to the latest and most advanced software version for virtual autosurgery via telemedicine. This is preferable to operating from a CD-ROM (or DVD, or other appropriate computer format, etc.). If a CD-ROM were simply sold to a prospective patient, obsoleteness could be corrected only by the patient purchasing a new updated CD-ROM, or purchasing a new on-line upgrade, which may pose a cost barrier to many individuals. Additionally, as new instructions become available to make the virtual autosurgery easier to perform, or easier to understand, having these new instructions instantly on-line adds increased efficiency and lessens the potential frustration of the end user (the “surgeon”/patient).

An individual interested in performing virtual autosurgery via telemedicine logs onto an appropriate website on the world wide web. The process is interactive and the central processing site's computer software system is completely automated, as information is transmitted back and forth between the central processing site's computer system and the patient's distant remote site computer system. To enhance the accuracy and verisimilitude of virtual cosmetic plastic autosurgery via telemedicine, different software versions are made available for men and for women. In addition, an individual interested in using the present invention can use age-matched software versions. It is inappropriate for a woman 75 years of age to be transmitted autosurgical results intended for a woman 25 years old. The converse also holds true. The preferred embodiment, therefore, can supply different software programs for the following age groups: 21-25 years of age; 26-30 years of age; 31-36 years of age; 37-42 years of age; 43-49 years of age; 50-57 years of age; 58-63 years of age; 64-69 years of age; 70-75 years of age; 76-79 years of age; 80-85 years of age; and, over 86 years of age.

These categories can certainly be modified, and other categories, such as height, weight, skin color and skin tone, etc., expanded and modified, as more experience is gained with the system. Data compression can also be made available, as required. “Informed Consent” for the present invention can be achieved by having the patient who is desirous of telemetric virtual autosurgery indicate his or her complete understanding that the virtual operation(s) being performed are simulations, and, although best efforts are made to have the virtual surgical procedures as realistic as possible, said surgical procedure(s) cannot be guaranteed to be practical, or even desirable, in a real-life surgical setting. For real-life surgery, an experienced and qualified plastic or cosmetic surgeon must be consulted, and risks, alternatives, and realistic potential benefits must be explored extremely conscientiously and thoroughly. Real-life surgical risks include, but are not limited to, death, loss of function, infection, poor healing, allergic reactions, unsatisfactory result, etc.

The fundamental requirements of the present invention, then, are as follows. A central processing site's computer system is programmed with appropriate software to standardize, and to calibrate for virtual surgery, appropriate digitized photographs received over a long-distance carrier, and, to perform required virtual surgical changes to said digitized photographs, as ordered and directed by a person at a distant remote site. A computer with a display monitor at a distant remote site receives data from, and transmits data to, the central processing site's computer, said data being related to cosmetic and plastic surgery. A long-distance carrier transmits data interactively between the central processing site's computer and the distant remote site's computer. The preferred long-distance carrier is the Internet. The preferred virtual surgical procedures, as stated above, are in the field of cosmetic surgery and plastic surgery.

### Steps of a Preferred Embodiment of the Procedure

1. Person at Distant Remote Site logs onto appropriate website of Central Processing Site.

2. Appropriate questions are asked by computer at Central Processing Site of person at Distant Remote Site (age, sex, height, weight, etc.).

3. Person at Distant Remote Site responds to questions posed by Central Processing Site computer in Step 2, and then transmits scanned photographs (or images from video camera) to Central Processing Site, which processes images into the proper predetermined standardized format for computerized morphing and simulation.

4. Appropriate questions are asked by computer at Central Processing Site of person at Distant Remote Site (what are patient's dissatisfactions with present appearance, procedure desired, etc.).

5. Person at Distant Remote Site responds to questions posed by Central Processing Site computer in Step 4.

6. Various surgical options for a particular procedure are interactively presented by computer at Central Processing Site to person at Distant Remote Site. Such options are automatically morphed and simulated by the computer at Central Processing Site, with appropriate blending of skin color and skin tone, such that realistic examples of said surgery are transmitted to the person at the Distant Remote Site.

7. After reviewing the option(s) presented by the computer at Central Processing Site, the person at the Distant Remote Site is asked further questions and has the opportunity to see multiple variations of the morphing/simulations representing the virtual surgical procedure performed by the computer at Central Processing Site.

8. Continuous on-line interactivity: The person at the Distant Remote Site is engaged in an interactive on-line dialogue with the computer software of the Central Processing Site.

9. This “conversation” between the person at the Distant Remote Site and the computer at the Central Processing Site continues, as required, to produce a realistic and true-to-life virtual surgical result for the patient. Real-life surgery is simulated, but without the attendant physical risks.

Note (a) Any of the above steps (and others which may be required to establish and to maintain logical dialogue interactively back and forth between the person at the Distant Remote Site and the computer at the Central Processing Site) may be repeated at any time. In addition a person may not like the final appearance of a particular virtual cosmetic plastic procedure, and the entire procedure, or steps thereof, may be deleted at the “surgeon”/patient's request.

Note (b) More than one virtual surgical procedure may be performed, but it is recommended that these be sequential, rather than simultaneous, to avoid confusion and to maintain as realistic an approach as possible.

Note (c) The present invention is interactive on-line virtual cosmetic plastic surgery via telemedicine. The surgery is entirely automated by the computer at the Central Processing Site, but is under the control of the person at the Distant Remote Site directing interactively the “autosurgery.” The “patient,” in essence, is the “surgeon.”

The present invention, then, is a novel and valuable educational tool which allows an individual interested in cosmetic and plastic surgery to learn more first-hand about the possibilities through auto-directed, automated, computerized, interactive, on-line, telemetric, simulated cosmetic and plastic surgical procedures “virtually” performed upon the individual, over long-distance carrier.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

I claim:

1. A self-performed virtual cosmetic surgery system, comprising:
a plurality of computers at a plurality of remote sites, said plurality of remote computers each having a video display device and at least one input device;
a computer at a central site, said central computer being programmed to receive original digital images of patients, to receive patient data, to receive patient image modification commands, to standardize said original patient images, to analyze said original patient images, to analyze said patient data, to analyze said patient image modification commands according to current medical protocols, and to generate modified digital patient images; and
a data transmission system connected to transmit said image modification commands from said plurality of remote computers to said central computer, and to transmit said modified patient images from said central computer to said plurality of remote computers.

2. The virtual cosmetic surgery system recited in claim 1, wherein said at least one input device comprises a scanner.

3. The virtual cosmetic surgery system recited in claim 1, wherein said at least one input device comprises a digital camera.

4. The virtual cosmetic surgery system recited in claim 1, wherein said at least one input device comprises a video camera.

5. The virtual cosmetic surgery system recited in claim 1, wherein said at least one input device comprises a keyboard.

6. The virtual cosmetic surgery system recited in claim 1, wherein said at least one input device comprises a mouse.

7. The virtual cosmetic surgery system recited in claim 1, wherein said data transmission system comprises the Internet.

8. The virtual cosmetic surgery system recited in claim 1, wherein said central computer is further programmed to provide alternative image modification schemes to said plurality of remote computers.

9. The virtual cosmetic surgery system recited in claim 8, wherein said image modification scheme comprises a computerized scheme for modifying the size of a selected body part.

10. The virtual cosmetic surgery system recited in claim 8, wherein said image modification scheme comprises a computerized scheme for modifying the orientation of a selected body part.

11. The virtual cosmetic surgery system recited in claim 10, wherein said scheme for modifying the orientation of a selected body part comprises a computerized scheme for rotating a selected body part.

12. The virtual cosmetic surgery system recited in claim 8, wherein said image modification scheme comprises a computerized selection of alternative configurations for a selected body part.

13. A self-performed virtual cosmetic surgery system, comprising:
a plurality of computers at a plurality of remote sites, said plurality of remote computers each having a video display device, a patient image input device, and at least one data input device;
a computer at a central site, said central computer being programmed to receive original digital images of patients via said patient image input device, to receive patient data via said at least one data input device, to receive patient image modification commands via said at least one data input device, to standardize said original patient images, to analyze said original patient images, to analyze said patient data, to analyze said patient image modification commands, according to current medical protocols, and to generate modified digital patient images; and
a data transmission system connected to transmit said original digital patient images, said patient data, and said patient image modification commands from said plurality of remote computers to said central computer, and to transmit said modified patient images from said central computer to said plurality of remote computers.

14. A method for self-performance of virtual cosmetic surgery, comprising:
providing a plurality of remote computers at a plurality of remotely located sites;
providing a central computer at a central site;
inputting an original digital image of a patient into said central computer;
inputting data relative to said patient into said central computer;
inputting image modification commands into said at least one remote computer;
transmitting said image modification commands from said at least one remote computer to said central computer via a data transmission system;
standardizing said original patient image with said central computer;
analyzing said original patient image, said patient data, and said image modification commands, according to current medical protocols, with said central computer;
generating a modified patient image with said central computer, according to said image modification commands;
transmitting said modified patient image from said central computer to said at least one remote computer via a data transmission system; and
displaying said modified patient image on a video display device connected to said at least one remote computer.

15. The virtual cosmetic surgery method recited in claim 14, wherein said standardizing of said original patient image comprises revising said image to a standard size to match image sizes for various alternative body part configurations.

16. The virtual cosmetic surgery method recited in claim 14, wherein said analysis of said original patient image, said patient data, and said image modification commands, comprises calculation of expected outcomes for image modification schemes selected by a particular patient.

17. The virtual cosmetic surgery method recited in claim 14, further comprising providing alternative image modification schemes to said plurality of remote computers, with said central computer.

18. The virtual cosmetic surgery method recited in claim 17, wherein said provision of alternative image modification schemes comprises providing a computerized scheme for modifying the size of a selected body part.

19. The virtual cosmetic surgery method recited in claim 17, wherein said provision of alternative image modification schemes comprises providing a computerized scheme for modifying the orientation of a selected body part.

20. The virtual cosmetic surgery method recited in claim 19, wherein said provision of a scheme for modifying the orientation of a selected body part comprises providing a computerized scheme for rotating a selected body part.

21. The virtual cosmetic surgery method recited in claim 17, wherein said provision of alternative image modification schemes comprises providing a computerized selection of alternative configurations for a selected body part.

22. The virtual cosmetic surgery method recited in claim 14, further comprising inputting said original digital image of a patient into said central computer via said at least one remote computer and via said data transmission system.

23. The virtual cosmetic surgery method recited in claim 14, further comprising:
providing a photograph of a patient to an operator of said central computer via a mail service; and
inputting said original digital image of the patient into said central computer via an image input device connected to said central computer.

24. The virtual cosmetic surgery method recited in claim 14, further comprising inputting said patient data into said central computer via said at least one remote computer and via said data transmission system.

25. The virtual cosmetic surgery method recited in claim 14, further comprising:
providing said patient data to an operator of said central computer via a mail service; and
inputting said patient data into said central computer via a data input device connected to said central computer.

26. The virtual cosmetic surgery method recited in claim 14, further comprising matching said medical protocols to the age of the patient.

27. The virtual cosmetic surgery method recited in claim 14, further comprising matching said medical protocols to the sex of the patient.
